(19) United States
(12) Patent Application Publication
(10) Pub. No.: US 2022/0272978 A1
(43) Pub. Date: Sep. 1, 2022

(54) AGROCHEMICAL LIQUID MIXTURE CONTAINING TETRACONAZOLE AND RELATIVE USE AS FUNGICIDE IN AGRICULTURAL CROPS

(71) Applicant: ISAGRO S.p.A., Milano (IT)

(72) Inventors: Claudio DACARRO, Milano (IT); Elisa GALIMBERTI, Lissone (MB) (IT); Paolo BELLANDI, Carcare (SV) (IT)

(21) Appl. No.: 17/625,162

(22) PCT Filed: Jul. 29, 2020
(86) PCT No.: PCT/IB2020/057138

§ 371 Date: Jan. 6, 2022

(30) Foreign Application Priority Data
Jul. 31, 2019 (IT) 102019000013446

(51) Int. Cl. A01N 43/653; A01N 59/20; A01N 25/04

(52) U.S. Cl. CPC A01N 43/653; A01N 59/20; A01N 25/04

(57) ABSTRACT

The present invention concerns an agrochemical liquid mixture comprising: —an oil phase comprising at least tetraconazole and, optionally, at least one co-solvent; —at least one agrochemical active ingredient, other than tetraconazole, dispersed or dissolved in said oil phase; wherein the total amount of said tetraconazole and said at least one agrochemical active ingredient other than tetraconazole is equal to or greater than 40% by weight, preferably equal to or greater than 45% by weight with respect to the weight of the mixture. The present invention also concerns the use of the aforesaid agrochemical liquid mixture as a fungicide in crop plants.

The present invention concerns a liquid agrochemical mixture containing tetraconazole and the relative use as a fungicide in agricultural crops.

### BACKGROUND

Tetraconazole, that is 2-(2,4-dichlorophenyl)-3-(1H-1,2,4-triazol-1-yl)propyl-1,1,2,2-tetrafluoroethylether having the following chemical structure

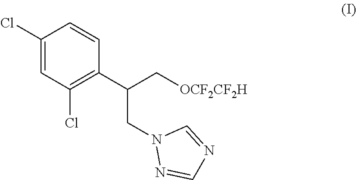

is a broad spectrum triazole fungicide, whose action is carried out by inhibiting the biosynthesis of ergosterol, a component that plays an important role in the formation, stability and functioning of fungal cell membranes.

Tetraconazole is traditionally used in its racemic form, but it can also be used as an optically active isomer, i.e. as an (R) or (S) isomer.

Numerous formulations containing ergosterol biosynthesis inhibitors for use in the agrochemical sector are known in the art. Such formulations can be in the form of solid or liquid preparations, or in the form of solid suspensions in liquids.

Tetraconazole at room temperature appears as a viscous liquid and is therefore not suitable for being formulated as a suspension of solid particles in a liquid medium. For this reason, formulations based on tetraconazole only are usually produced by dissolving the active ingredient in a suitable solvent, in order to obtain a liquid formulation that is stable over time.

Furthermore, in order to broaden the spectrum of action and decrease the phenomenon of resistance, tetraconazole can be used in mixture with other active ingredients. Such mixtures are usually formulated as suspoemulsions (SE), if the additional active ingredient is in solid form. Suspoemulsions are a type of liquid formulation characterized by the presence of two or more active ingredients in which at least one of them is in the form of a water emulsion and at least one of them is in the form of solid particles dispersed in water.

As is known to those skilled in the art, suspoemulsions are complex heterogeneous formulations subject to physical degradation phenomena over time, such as homo-flocculation, hetero-flocculation or coalescence.

The suspoemulsions also have a limit in the maximum concentration of active ingredient they can contain, which is due to the excessive viscosity of the system—which comprises, as a dispersing medium, both water and an organic solvent—and the need to use high concentrations of surfactants to keep the formulation stable.

Some agro-drugs can be validly used in the form of dispersions in oil (OD), a type of liquid agronomic formulation in which one or more active ingredients together with co-formulant compounds are dispersed in an oil phase; the suspension thus obtained is optionally subsequently subjected to grinding until particles of active ingredient are obtained in a desired finely divided form.

The dispersions in oil generally demonstrate greater stability than suspoemulsions and therefore allow the formulation of active ingredients that are not stable in an aqueous environment, i.e. substances that chemically react by degrading in water, or that give rise to phenomena of physical instability, such as flocculation or crystallization.

However, it is known to those skilled in the art that even in dispersions in oil the total concentration of the active substances is rather limited, since the formulations having relatively high concentrations of active ingredients are unstable, excessively viscous and therefore not effectively usable for agronomic purposes.

Therefore, in the agronomic sector, the need for liquid formulations with relatively high concentrations of agrochemical active ingredients is strongly felt, so as to reduce the volume of the final formulation that must be used to reach the dose of use in each treatment, with a consequent reduction of costs of production, transport and disposal.

### DESCRIPTION

The Applicant has found that the aforementioned drawbacks of the state of the art, which will appear more evident in the following description, can be overcome by using tetraconazole, besides as an agrochemical active ingredient, as a dispersing medium for the production of a liquid agrochemical mixture containing one or more additional agrochemical active ingredients. It has in fact been observed that tetraconazole can be effectively used to dissolve or disperse, completely or partially, additional agrochemical active ingredients, thus avoiding the use of conventional diluting oil phases or in any case using relatively low amounts, significantly lower than those used in agrochemical liquid mixtures of the known art.

The liquid agrochemical mixture in which tetraconazole performs both the function of agrochemical active ingredient and the function of oil dispersing phase is surprisingly concentrated, stable over time and with an excellent propensity to create a homogeneous and stable dispersion in water.

A first object of the present invention is therefore a liquid agrochemical mixture comprising:
an oil phase comprising at least tetraconazole and, optionally, at least one co-solvent;
at least one agrochemical active ingredient, other than tetraconazole, dispersed or dissolved in said oil phase;

wherein the total amount of said tetraconazole and said at least one agrochemical active ingredient other than tetraconazole is equal to or greater than 40% by weight, preferably equal to or greater than 45% by weight with respect to the weight of the mixture.

For the purposes of the present description and of the claims, the verb “to comprise” and all the terms deriving therefrom also include the meaning of the verb “to consist of” and the terms deriving therefrom.

The numerical limits and intervals expressed in the present description and appended claims also include the numerical value or numerical values mentioned. Furthermore, all ranges include any combination of maximum and minimum values indicated and any intermediate sub-ranges, even if not explicitly mentioned.

The term “active agrochemical ingredient” or “agrochemical compound” is intended as an active substance which protects against harmful organisms, conserves and/or controls a crop. The active agrochemical ingredients are selected, for example, from: fungicides, insecticides, nematocides, herbicides, phytoprotectors and/or growth regulators. Fungicides are the particularly preferred agrochemical compounds.

The liquid agrochemical mixture according to the present invention, in addition to tetraconazole, comprises at least one additional agrochemical active ingredient, other than tetraconazole, or a mixture of two or more additional agrochemical active ingredients other than tetraconazole.

The additional agrochemical active ingredients other than tetraconazole can be present in the liquid agrochemical mixture as dispersed solids having low solubility in the oil phase (solubility lower than 10 g/l at 25° C.) or they can be completely dissolved or partially dissolved in the oil phase (greater solubility at 10 g/l at 25° C.)

The additional active ingredients can be, for example, fungicides described in FRAC (Fungicide Resistance Action Committee) and having a mode of action selected from:

A. Synthesis inhibitors of nucleic acids;

B. Mitosis and cell division inhibitors;

C. Respiratory chain inhibitors;

D. Synthesis inhibitors of amino acids and proteins;

E. Signal transduction inhibitors;

F. Lipid and membrane synthesis inhibitors;

G. Ergosterol synthesis inhibitors;

I. Melanin biosynthesis inhibitors;

M. Compounds with multisite activity;

P. Host plant defence inductors;

Z. Compounds with unknown mode of action.

Examples of fungicides having a mode of action as synthesis inhibitors of nucleic acids (group A) which may be present in the agrochemical mixture are: benalaxyl, benalaxyl-M (kiralaxyl), bupirimate, dimethirimol, ethirimol, furalaxyl, metalaxyl, metalaxyl-M, ofurace, oxadixyl.

Examples of fungicides having a mode of action such as mitosis and cell division inhibitors (group B) which may be present in the agrochemical mixture are: benomyl, carbendazim, diethofencarb, ethaboxam, fluopicolide, fuberidazole, metrafenone, pencycuron, pyriofenone, thiabendazole, thiophanate-methyl, zoxamide.

Preferably said fungicides belonging to group B are: carbendazim, diethofencarb, metrafenone, pyriofenone, thiophanate-methyl.

Examples of fungicides having a mode of action as respiratory chain inhibitors (group C) can act on complex I (subgroup C1), complex II (subgroup C2), complex III at Qo and Qi sites (subgroups C3 and C4 respectively), such as uncouplers of oxidative phosphorylation (subgroup C5) or as inhibitors of oxidative phosphorylation (subgroup C6) which may be present in the agrochemical mixture are:

C1: diflumetorim, fenazaquin, tolfenpyrad;

C2: benodanil, benzovindiflupyr, bixafen, boscalid, carboxin, fenfuram, fluindapyr, fluopyram, flutolanil, fluxapyroxad, furametpyr, inpyrfluxam, isofetamid, isoflucypram, isopyrazam, mepronil, oxycarboxin, penflufen, penthiopyrad, pydiflumetofen, pyraziflumid, sedaxane, thifluzamide; preferably said fungicides of subgroup C2 are benzovindiflupyr, bixafen, boscalid, fluindapyr, fluopyram, flutolanil, fluxapyroxad, furametpyr, isofetamid, isopyrazam, penflufen, penthiopyrad, pydiflumetofen, sedaxane, thifluzamide;

C3: azoxystrobin, coumoxystrobin, dimoxystrobin, enoxastrobin, famoxadone, fenamidone, fenaminostrobin, flufenoxystrobin, fluoxastrobin, kresoxim-methyl, mandestrobin, metominostrobin, orysastrobin, picoxystrobin, pyraclostrobin, pyrametostrobin, pyraoxystrobin, pyribencarb, triclopyricarb, trifloxystrobin; preferably said fungicides of subgroup C3 are: azoxystrobin, famoxadone, fenamidone, fluoxastrobin, kresoxim-methyl, mandestrobin, metominostrobin, picoxystrobin, pyraclostrobin, pyribencarb, trifloxystrobin;

C4: amisulbrom, cyazofamid, fenpicoxamid, florypicoxamid;

C5: binapacryl, fluazinam, meptyldinocap; preferably said fungicides of subgroup C5 are: fluazinam, meptyldinocap;

C6: fentin acetate, fentin chloride, fentin hydroxide.

Examples of fungicides having a mode of action as synthesis inhibitors of amino acids and proteins (group D) which may be present in the agrochemical mixture are: blasticidin-S, cyprodinil, kasugamycin, mepanipyrim, oxytetracycline, pyrimethanil.

Preferably said fungicides belonging to group D are: cyprodinil.

Examples of fungicides having a mode of action as signal transduction inhibitors (group E) which may be present in the agrochemical mixture are: chlozolinate, fenpiclonil, fludioxonil, iprodione, procymidone, proquinazid, quinoxyfen, vinclozolin.

Preferably said fungicides belonging to group E are: fludioxonil, proquinazid, quinoxyfen.

Examples of fungicides having a mode of action as lipid and membrane synthesis inhibitors (group F) which may be present in the agrochemical mixture are: biphenyl, chloroneb, edifenphos, plant extracts, etridiazole, iprobenfos, isoprothiolane, oxathiapiprolin, propamocarb, prothiocarb, pyrazophos, quintozene, tecnazene, tolclofos-methyl.

Preferably said fungicides belonging to group F are plant extracts such as eugenol, geraniol, Melaleuca alternifolia, thymol.

Examples of fungicides having a mode of action as ergosterol synthesis inhibitors (group G) can act as demethylase inhibitors (DMI) (subgroup G1), reductase inhibitors (SBI) (subgroup G2) or as ketoreductase inhibitors (KBI) (subgroup G3) which may be present in the agrochemical mixture are:

G1: azaconazole, bitertanol, bromuconazole, cyproconazole, difenoconazole, diniconazole, epoxiconazole, etaconazole, fenarimol, fenbuconazole, fluquinconazole, flusilazole, flutriafol, hexaconazole, imazalil, imibenconazole, ipconazole, ipfentrifluconazole, mefentrifluconazole, metconazole, myclobutanil, nuarimol, oxpoconazole, paclobutrazol, pefurazoate, penconazole, prochloraz, propiconazole, prothioconazole, pyrifenox, pyrisoxazole, simeconazole, tebuconazole, triadimefon, triadimenol, triflumizole, triforine, triticonazole; preferably said fungicides of subgroup G1 are: difenoconazole, flutriafol, hexaconazole, ipfentrifluconazole, mefentrifluconazole, metconazole, myclobutanil, prothioconazole;

G2: fenpropidin, fenpropimorph, spiroxamine, tridemorph; preferably said fungicides of subgroup G2 are: fenpropidin, spiroxamine;

G3: fenhexamid, fenpyrazamine.

Examples of fungicides having a mode of action as melanin synthesis inhibitors (group I) which may be present in the agrochemical mixture are: carpropamid, diclocymet, fenoxanil, pyroquilon, tolprocarb, tricyclazole.

Preferably said fungicides of group I are: tricyclazole.

Examples of fungicides having a mode of action as compounds with multisite activity (group M) which may be present in the agrochemical mixture are: anilazine, Bordeaux mixture, captafol, captan, chinomethionat, chlorothalonil, copper hydroxide, copper naphthenate, copper oxide, copper oxychloride, copper sulphate, dichlofluanid, dithianon, folpet, guazatine, iminoctadine, mancozeb, maneb, metiram, metiram-zinc, methasulfocarb, oxine-copper, propineb, sulfur, thiram, tolylfluanid, zineb, ziram.

Preferably said fungicides of group M are: Bordeaux mixture, captafol, captan, chlorothalonil, copper hydroxide, copper naphthenate, copper oxide, copper oxychloride, copper sulphate, folpet, mancozeb, metiram, tolylfluanid.

Examples of fungicides having a mode of action as host plant defence inductors (group P) which may be present in the liquid agrochemical mixture are: acibenzolar-S-methyl, fosetyl-Al, isothianil, laminarin, phosphorous acid, probenazole, thiadinil.

Preferably said fungicides of group P are laminarin, phosphorous acid.

Examples of fungicides having an unknown mode of action (group Z) which may be present in the liquid agrochemical mixture are: cyflufenamid, cymoxanil, flutianil, dodine, tebufloquin, tecloftalam.

Preferably, said fungicides of group Z are: cyflufenamid, flutianil.

Preferably, the aforesaid at least one agrochemical active ingredient other than tetraconazole is a compound selected from the following compounds: prothioconazole, azoxystrobin, copper hydroxide, copper oxychloride, copper sulphate, chlorothalonil, and mixtures thereof.

When the liquid agrochemical mixture contains one or more additional agrochemical active ingredients, the total concentration of the agrochemical active ingredients including tetraconazole is preferably in the range from 45% to 85% by weight, more preferably from 48% to 70% by weight, with respect to the weight of the liquid agrochemical mixture.

Preferably, the weight ratio of tetraconazole to the additional one or more agrochemical active ingredients other than tetraconazole is in the range from 10:1 to 1:10.

Preferably, tetraconazole is present in the liquid agrochemical mixture in an amount ranging from 1% to 60% by weight, more preferably from 10% to 55% by weight, with respect to the weight of the mixture.

The oil phase may include at least one co-solvent. In particular, the co-solvent is used when the mass of tetraconazole present in the liquid agrochemical mixture is not sufficient to dissolve or disperse the one or more additional active ingredients present.

When the co-solvent is present, the concentration thereof is preferably not greater than 40% by weight with respect to the weight of the liquid agrochemical mixture, more preferably the concentration is lower than 35% by weight.

When tetraconazole is present in an amount sufficient to dissolve or disperse the additional active agrochemical ingredients, the co-solvent can be absent or possibly present in a relatively low amount, preferably not higher than 1% by weight, more preferably not higher than 0.5% by weight, with respect to the weight of the liquid agrochemical mixture.

In one embodiment, when in the liquid agrochemical mixture the weight ratio of tetraconazole to the total weight of the additional agrochemical active ingredients other than tetraconazole is greater than 1:1, preferably when said ratio is higher than 1:1 and lower than or equal to 3.5:1, the oil phase includes at least one co-solvent in a total amount not exceeding 1% by weight with respect to the weight of the mixture.

In another embodiment, when in the agrochemical mixture the weight ratio of tetraconazole to the total weight of the additional agrochemical active ingredients other than tetraconazole is equal to or lower than 1:1, preferably when said ratio is in the range from 1:1.1 to 1:6, said oil phase includes at least one co-solvent in a total amount equal to or higher than 1% by weight, preferably in the range from 1% to 40% by weight with respect to the weight of the mixture, for example in the range 2%-35% by weight.

The co-solvent is an organic liquid phase, substantially immiscible with water. The co-solvent may comprise, for example, one of the following compounds: petroleum distillates, such as benzene-derived aromatic hydrocarbons, such as alkyl benzenes and alkyl naphthalenes (e.g. toluene, xylene); aliphatic hydrocarbons (e.g. hexane, octane, cyclohexane, etc.); polyalkylene glycol ethers; fatty acid amides; dialkylene carbonates; aliphatic or paraffinic mineral oils, mixtures of aromatic and aliphatic hydrocarbons; vegetable oils (e.g. rapeseed oil, soybean oil, olive oil, castor oil, linseed oil and the like) as well as the derivatives esterified with C₁-C₆ alkyls, in particular C₁-C₄ alkyl esters of C₁₂-C₂₂ fatty acids; glycerine; monopropylene glycol, linear dialkyl esters of dicarboxylic acids, such as dimethyl glutarate, dimethyl succinate, dimethyl adipate and mixtures thereof (Rhodiasolv® RDPE).

The esterified derivatives of vegetable oils can be obtained by transesterification of vegetable oils with short-chain alcohol, such as methanol, ethanol, butanol and pentanol, or by esterification of the fractions of fatty acid derived from the saponification of vegetable oils with the same alcohols.

Preferably, the oil phase is a vegetable oil or a relative esterified derivative C₁-C₆. More preferably, the oil phase is rapeseed oil, even more preferably it is a methyl ester of rapeseed oil.

The oil phase may also comprise a mixture of two or more co-solvents.

The liquid agrochemical mixture can also comprise additional co-formulants, such as at least one non-ionic surfactant and at least one rheological modifier.

The non-ionic surfactant mainly carries out the function of emulsifier, i.e. its presence in the liquid agrochemical mixture favours the emulsification of the oil phase with the water used for the dilution thereof for the preparation of a ready-to-use formulation. Preferably, the emulsifying effect is obtained by using an emulsifying system comprising at least one non-ionic surfactant in combination with at least one anionic surfactant.

Preferably, the at least one non-ionic emulsifying surfactant is selected from: ethoxylated block copolymers, etho-propoxylated block copolymers, ethoxylated tristyrylphenoles, etho-propoxylated tristyrylphenols, ethoxylated tristyrylphenol phosphates (acid form), ethoxylated tristyrylphenol sulphates (acid form), sorbitan monolaurates, ethoxylated sorbitan monolaurates, sorbitan mono-oleates, ethoxylated sorbitan mono-oleates, ethoxylated vegetable oil, ethoxylated fatty alcohols, organosilicon compounds and mixtures thereof. More preferably the at least one non-ionic surfactant is an etho-propoxylated tristyrylphenol.

Preferably, the at least one emulsifying non-ionic surfactant is present in the liquid agrochemical mixture in a total amount ranging from 1% to 40% by weight, more preferably from 3% to 25% by weight, with respect to the weight of said agrochemical mixture.

Preferably, said at least one anionic surfactant is selected from: ethoxylated tristyrylphenol phosphates (salified form), ethoxylated tristyrylphenol sulphates (salified form), calcium dodecyl benzene sulphonate and mixtures thereof. More preferably, said at least one anionic surfactant is selected from: calcium dodecyl benzene sulphonate and ethoxylated tristyrylphenol phosphates (salified form).

If present, said at least one anionic surfactant is contained in the liquid agrochemical mixture in a total amount ranging between 1% and 40% by weight, more preferably between 5% and 30% by weight, with respect to the weight of said agrochemical mixture.

Preferably, the rheological modifier is selected from: clay, modified clay, high surface area silica, cellulose derivatives, hydrogenated castor oil and mixtures thereof. Preferably, the rheological modifier is a clay, such as atapulgite or bentonite, or is a high surface area silica.

Preferably, the rheological modifier is present in the liquid agrochemical mixture in a total amount in the range between 0.1% and 10% by weight, more preferably between 1% and 7% by weight, with respect to the weight of said agrochemical mixture.

Optionally, the liquid agrochemical mixture according to the present invention can comprise additional co-formulants other than those mentioned above, such as, for example, compounds for improving the biological activity, anti-drift agents, penetrating agents, wetting agents, anti-foaming agents, stabilizers, sequestering agents, anti-corrosion agents, tackifying agents and the like.

The preparation of the liquid agrochemical mixture according to the present invention can be carried out according to known methods, mixing the components in the desired ratios with no particular limitations in the order in which the components are mixed.

The liquid agrochemical mixtures according to the present invention show a high fungicidal activity and do not show substantial phytotoxicity towards the crops to which they are applied.

A further object of the present invention is therefore the use of a liquid agrochemical mixture according to the present description for the control of phytopathogenic fungi in an agricultural crop.

Another object of the present invention is a method for controlling phytopathogenic fungi in an agricultural crop which includes applying at least an effective dose of a liquid agrochemical mixture of the present description to an agricultural crop.

Examples of crops of interest are: fruit trees, vegetables and extensive crops, such as rice, wheat and soy.

The liquid agrochemical mixture according to the present invention can be applied, after adding water, to any part of a plant, for example on leaves, stems, branches and roots, or on the seeds themselves before sowing, or on the soil where the plant grows. The liquid agrochemical mixture according to the present invention can also be used to prepare, following dilution in water, a suspoemulsion comprising an emulsion of the oil phase containing tetraconazole and a suspension of solid particles of at least a second agrochemical active ingredient other than tetraconazole. The suspoemulsion may comprise other ingredients, such as wetting agents, emulsifying agents, stabilizing agents, etc. The additional ingredients may be present in the liquid agrochemical mixture or in the dilution water used to prepare the suspoemulsion.

A further object of the present invention is therefore a procedure for preparing an agronomic formulation, preferably in the form of a suspoemulsion, comprising:
supplying at least one liquid agrochemical mixture according to the present description,
diluting said liquid agrochemical mixture with water to obtain said agronomic formulation.

Water is added to the liquid agrochemical mixture in the amount necessary to achieve the required agronomic formulation volume.

The amount of liquid agrochemical mixture or agronomic formulation to be applied to an agricultural crop to obtain the desired agrochemical effect can vary according to various factors, such as, for example, the type of crop, the climatic conditions, the characteristics of the soil, the method of application. Said amount can be easily determined by the person skilled in the art on the basis of his technical knowledge and routine experiments.

In order to better illustrate the invention, the following examples are now provided, which are to be considered illustrative and non-limiting.

### EXAMPLES

### Liquid Agrochemical Mixtures Containing Tetraconazole

Liquid agrochemical mixtures n. 1-7 according to the present invention having the compositions shown in table 1 were prepared.

The commercial products used for the preparation of the aforesaid mixtures are as follows:

Amesolv CME, co-solvent, a mixture of methyl esters of fatty acids coming from rapeseed oil;

Soprophor 796/P, non-ionic surfactant, etho-propoxylated tristyrylphenol;

Rhodacal 60/BE, anionic surfactant, calcium salt of benzenesulfonic acid;

Soprophor FLK, anionic surfactant, tristyrylphenol ethoxylate phosphate, K salt;

Emulson AG/PE, non-ionic surfactant, etho-propoxylated block copolymer;

Alkamuls T/20, non-ionic surfactant, ethoxylated sorbitan monolaurate;

Imbirol OT/NA/70, anionic surfactant, sodium docusate;

Geronol ODESSA 05, mixture of non-ionic and anionic emulsifiers in oil, with a rheological modifier;

Alkamuls T85V, non-ionic surfactant, ethoxylated trioletate sorbitan;

Rhodiasolv RP/DE, co-solvent, is a mixture of dimethyl glutarate, dimethyl succinate and dimethyl adipate;

Attagel 40, rheological modifier, attapulgite;

PVP-K30, rheological modifier, polyvinyl pyrrolidone;

Alkamuls OR36, non-ionic surfactant, is an ethoxylated castor oil;

BreakThru AF 5503, non-ionic surfactant, organosilicon compound with antifoam function;

BreakThru OE 440, non-ionic surfactant, organosilicon compound.

TABLE 1

| | 1 | 2 | 3 | 4 | 5 | 6 | 7 |
|---|---|---|---|---|---|---|---|
| | % (by | % (by | % (by | % (by | % (by | % (by | % (by |
| Components | weight) | weight) | weight) | weight) | weight) | weight) | weight) |
| Tetraconazole (96% | 21.6 | 20 | 15 | 25 | 32 | 34 | 50 |
| technical) - | | | | | | | |
| Azoxystrobin (98% | | | | 25 | | | 14 |
| technical) | | | | | | | |
| Copper oxychloride | 24.3 | 30.1 | | | | | |
| (Copper content = 57%) | | | | | | | |
| Copper hydroxide (II) | 23.1 | | | | | | |
| (copper content = 62%) | | | | | | | |
| Copper sulphate | | | | | | 34 | |
| Prothioconazole (98% | | | | | 31.5 | | |
| technical) | | | | | | | |
| Chlorothalonil (98% | | | 34 | | | | |
| technical) | | | | | | | |
| Odessa 05 (TNI + TA + MR) | 10 | | | | | | |
| Amesolv CME | 12.5 | | 21 | | | | |
| (co-solvent) | | | | | | | |
| Soprophor 796/P (TNI) | | | 12 | | | | 20 |
| Rhodacal 60/BE (TA) | 4 | | 10 | 5 | | | 10 |
| Soprophor FLK (TA) | | | | | 20 | 15.3 | |
| Emulson AG/PE (TNI) | | 8 | | | | | |
| Alkamuls T/20 (TNI) | | | | | 10 | | |
| Imbirol OT/NA/70 (TA) | | 7 | | | 5 | | 4.6 |
| Monopropylene Glycol | | 31 | | | | | |
| (co-solvent) | | | | | | | |
| Rhodiasolv RP/DE | | | | 20 | | | |
| (co-solvent) | | | | | | | |
| Alkamuls T/85-V (TNI) | 3 | | | | | | |
| Attagel 40 (MR) | | 3.8 | 3 | 5 | | | |
| Bentonite (MR) | 1.5 | | | 2 | 1.5 | 1.2 | 1.2 |
| Silica (MR) | | | | | | 0.3 | |
| PVP K30 (MR) | | | | | | 0.2 | 0.2 |
| Alkamuls OR 36 | | | 5 | 13 | | 15 | |
| (TNI) | | | | | | | |
| BreakThru AF 5503 | | 0.1 | | | | | |
| (TNI) | | | | | | | |
| BreakThru OE 440 (TNI) | — | — | — | 5 | — | — | — |
| TOTAL | 100 | 100 | 100 | 100 | 100 | 100 | 100 |

TNI = non-ionic surfactant; TA = anionic surfactant; MR = rheological modifier.

Analyses of physical parameters were carried out on the mixtures n. 1-7 to verify the stability of the formulation at room temperature and after accelerated storage (Storage Stability Test, abbreviated SST—MT Cipac 46, which involves keeping the sample in a thermostated oven at 54° C. for a time of 14 days). The following parameters were assessed:
Appearance: visual analysis;
Viscosity: measured with a Brookfield RV viscometer, impeller 4 at 2.5 rpm, temperature 25° C.;
Wet sieve test: Cipac MT185;
Cold stability test: Cipac MT39.

The results of the assessments of the aforesaid parameters are shown in Table 2.

TABLE 2

| | Example 1 | Example 2 | Example 3 | Example 4 | Example 5 |
|---|---|---|---|---|---|
| Appearance | Green liquid; | Green liquid; | White liquid; | Yellow liquid; | White liquid; |
| room t. | No separation; | No separation; | No separation; | No separation; | No separation; |
| Appearance | Green liquid; | Green liquid; | White liquid; | Yellow liquid; | White liquid; |
| after SST | No separation; | No separation; | No separation; | No separation; | No separation; |
| Room t. | L4 2.5 rpm | L4 2.5 rpm | L3 20 rpm | L3 20 rpm | L3 20 rpm |
| viscosity | 13000 mPas | 15000 mPas | 6000 mPas | 9000 mPas | 8000 mPas |
| Viscosity | L4 2.5 rpm | L4 2.5 rpm | L3 20 rpm | L3 20 rpm | L3 20 rpm |
| after SST | 11000 mPas | 14000 mPas | 5500 mPas | 9000 mPas | 8000 mPas |
| 45 μm sieve | No residue | No residue | No residue | No residue | No residue |
| room t. | | | | | |
| 45 μm sieve | No residue | No residue | No residue | No residue | No residue |
| after SST | | | | | |
| Stability | No separation | No separation | No separation | No separation | No separation |
| at 0° C. | | | | | |

| | Example 6 | Example 7 |
|---|---|---|
| Appearance | Green liquid; | Yellow liquid; |
| room t. | No separation; | No separation; |
| Appearance | Green liquid; | Yellow liquid; |
| after SST | No separation; | No separation; |
| Room t. | L4 2.5 rpm | L4 2.5 rpm |
| viscosity | 10000 mPas | 12000 mPas |
| Viscosity | L4 2.5 rpm | L4 2.5 rpm |
| after SST | 8500 mPas | 11000 mPas |
| 45 μm sieve | No residue | No residue |
| room t. | | |
| 45 μm sieve | No residue | No residue |
| after SST | | |
| Stability | No separation | No separation |
| at 0° C. | | |

The liquid agrochemical mixtures according to the present invention contain high concentrations of active ingredients (from about 50% to about 70% by weight referred to the weight of the mixture), low concentrations of co-solvents (from about 12% to about 30% by weight referred to the weight of the mixture) and are stable during storage.

1. An agrochemical liquid mixture comprising:
an oil phase comprising at least tetraconazole and, optionally, at least one co-solvent;
at least one agrochemical active ingredient, other than tetraconazole, dispersed or dissolved in said oil phase;
wherein the total amount of said tetraconazole and said at least one agrochemical active ingredient other than tetraconazole is equal to or greater than 40% by weight.

2. The liquid agrochemical mixture according to claim 1, wherein said oil phase includes at least one co-solvent in a total amount not exceeding 40% by weight with respect to the weight of the mixture.

3. The liquid agrochemical mixture according to claim 1, wherein the weight ratio of said tetraconazole to said at least one agrochemical active ingredient other than tetraconazole is within the range from 10:1 to 1:10.

4. The liquid agrochemical mixture according to any one of the preceding claim 1, wherein when the weight ratio of said tetraconazole to said at least one agrochemical active ingredient other than tetraconazole is higher than 1:1 said oil phase includes at least one co-solvent in a total amount not exceeding 1% by weight with respect to the weight of the mixture.

5. The liquid agrochemical mixture according to claim 1, wherein the weight ratio of said tetraconazole to said at least one agrochemical active ingredient other than tetraconazole is equal to or less than 1:1 and said oil phase includes at least one co-solvent in a total amount equal to or higher than 1% by weight with respect to the weight of the mixture.

6. The liquid agrochemical mixture according to claim 1, wherein said at least one agrochemical active ingredient other than tetraconazole is a compound, having at least one mode of action selected from the group consisting of:
Synthesis inhibitors of nucleic acids;
Mitosis and cell division inhibitors;
Respiratory chain inhibitors;
Synthesis inhibitors of amino acids and proteins;
Signal transduction inhibitors;
Lipid and membrane synthesis inhibitors;
Ergosterol synthesis inhibitors;
Melanin biosynthesis inhibitors;
Compounds with multisite activity;
Host plant defence inductors; and
Compounds with unknown mode of action.

7. The liquid agrochemical mixture according to claim 6, wherein said at least one agrochemical active ingredient other than tetraconazole is a compound with multisite activity, selected from the group consisting of: anilazine, Bordeaux mixture, captafol, captan, chinomethionat, chlorothalonil, copper hydroxide, copper naphthenate, copper oxide, copper oxychloride, copper sulphate, dichlofluanid, dithianon, folpet, guazatine, iminoctadine, mancozeb, maneb, metiram, metiram-zinc, methasulfocarb, oxine-copper, propineb, sulfur, thiram, tolylfluanid, zineb, ziram, and mixtures thereof.

8. The liquid agrochemical mixture according to claim 6, wherein said at least one other agrochemical active ingredient other than tetraconazole is a compound inhibiting the respiratory chain complex III in the Qo site selected from the group consisting of: azoxystrobin, famoxadone, fenamidone, fluoxastrobin, kresoxim-methyl, mandestrobin, metominostrobin, picoxystrobin, pyraclostrobin, pyribencarb, trifloxystrobin, and mixtures thereof.

9. The liquid agrochemical mixture according to claim 6, wherein said at least one agrochemical active ingredient other than tetraconazole is a compound selected from the group consisting of: prothioconazole, azoxystrobin, copper hydroxide, copper oxychloride, copper sulphate, chlorothalonil, and mixtures thereof.

10. The liquid agrochemical mixture according to claim 1, further comprising at least one non-ionic surfactant in an amount ranging from 1% to 40% by weight with respect to the weight of the mixture.

11. The liquid agrochemical mixture according to claim 1, further comprising at least one anionic surfactant in an amount ranging from 1% to 40% by weight with respect to the weight of the mixture.

12. The liquid agrochemical mixture according to claim 1, further comprising at least one rheological modifier in an amount ranging from 0.1% to 10% by weight with respect to the weight of the mixture.

13. The liquid agrochemical mixture according to claim 1, wherein said co-solvent, when present, is selected from the group consisting of: aromatic hydrocarbons derived from benzene; aliphatic hydrocarbons; polyalkylene glycol ethers; fatty acid amides; dialkylene carbonates, aliphatic or paraffinic mineral oils, vegetable oils and related esterified derivatives, glycerin, and monopropylene glycol.

14. A method of preparing an agronomic formulation comprising:
supplying at least one liquid agrochemical mixture according to claim 1,
diluting said mixture with water to obtain said agronomic formulation.

15. (canceled)

16. The A method for controlling phytopathogenic fungi in an agricultural crop, comprising applying at least one effective dose of a liquid agrochemical mixture according to claim 1 to an agricultural crop.

17. The agrochemical liquid mixture of claim 1, wherein the total amount of said tetraconazole and said at least one agrochemical active ingredient other than tetraconazole is equal to or greater than 45% by weight with respect to the weight of the mixture.

18. The liquid agrochemical mixture according to claim 1, wherein when the weight ratio of said tetraconazole to said at least one agrochemical active ingredient other than tetraconazole is higher than 1:1 and lower than or equal to 3.5:1, said oil phase includes at least one co-solvent in a total amount not exceeding 1% by weight with respect to the weight of the mixture.

19. The liquid agrochemical mixture according to claim 5, wherein the weight ratio of said tetraconazole to said at least one agrochemical active ingredient other than tetraconazole is within the range from 1:1.1 to 1:6 and said oil phase includes at least one co-solvent in a total amount within the range of from 1% to 40% by weight with respect to the weight of the mixture.

20. The liquid agrochemical mixture according to claim 1, further comprising at least one non-ionic surfactant in an amount ranging from 3% to 25% by weight with respect to the weight of the mixture.

21. The liquid agrochemical mixture according to claim 1, further comprising at least one anionic surfactant in an amount ranging from 5% to 30% by weight with respect to the weight of the mixture.
